(19) United States
(12) Patent Application Publication
(10) Pub. No.: US 2008/0203734 A1
(43) Pub. Date: Aug. 28, 2008

(54) Wellbore rig generator engine power control

(76) Inventors: Mark Francis Grimes, Cypress, TX (US); Gregory Paul Cervenka, Houston, TX (US); Kent Hulick, Houston, TX (US)

Correspondence Address: Guy L. McClung, III, # 114, 5315B FM 1960 Road West, Houston, TX, 77069-4410, US

(21) Appl. No.: 11/983,214

(22) Filed: Nov. 7, 2007

Related U.S. Application Data
(60) Provisional application No. 60/902,725, filed on Feb. 22, 2007.

(51) Int. Cl. H02P 9/04; G06F 19/00

(52) U.S. Cl. 290/40 R; 701/101

(57) ABSTRACT

A system for controlling power load to a rig engine of a wellbore rig, the system including a controller for controlling a rig engine, a sensor for sensing the exhaust temperature of a rig engine, the sensor in communication with the controller for providing to the controller signals indicative of the exhaust temperature, and the controller maintaining power load to the rig engine based on said exhaust temperature. This abstract is provided to comply with the rules requiring an abstract which will allow a searcher or other reader to quickly ascertain the subject matter of the technical disclosure. It is submitted with the understanding that it will not be used to interpret or limit the scope or meaning of the claims, 37 CFR 1.72(b).

### CROSS-REFERENCE TO RELATED APPLICATIONS

The present invention and application claim priority under the Patent Laws based on U.S. Application Ser. No. 60/902,725 filed Feb. 22, 2007 co-owned with the present invention and incorporated herein in its entirety for all purposes.

### BACKGROUND OF THE INVENTION

1. Field Of The Invention

The present invention is directed, in certain aspects, to controlling generator engines, and in certain particular aspects, to controlling wellbore rig generator engines to control gas emissions that form; and in other aspects to power systems for rigs used in wellbore operations, e.g. drilling; to methods and systems and methods for recovering and using power generated by rig apparatuses; and to enhancing the quality of power used on a rig.

2. Description of Related Art

Rigs used for wellbore operations, both land based and offshore, use a wide variety of tools, apparatuses, appliances, systems and devices that use electrical power. Typically power is supplied by one or more generators that run on diesel fuel or other hydrocarbon fuel. Such rigs, including, but not limited to, drilling rigs and production platforms, have for example, drawworks, pumps, motors mud pumps, drive system(s) (rotary, power swivel, top drive), pipe racking systems, hydraulic power units, and/or a variety of rig utilities (lights, A/C units, appliances), electronics, and control systems for these things. Typical conventional drilling rigs have one or more alternating current (AC) power generators which provide power to silicon controlled rectifier(s) which convert the AC power to DC power, e.g. for DC motors of various tools and systems, and for DC-powered top drives or prime movers.

In certain prior systems, rig generators have engines that run on natural gas (or other relatively clean fuels). Such engines can be sluggish to respond to different power demands and this can negatively affect operations, e.g., but not limited to, tripping speeds. In many such engines, the engines must be heavily loaded (run at high power levels) so that catalytic converters associated with the engines run properly and efficiently. In many instances, a variety of wellbore operations are intermittent and it is difficult and/or expensive to maintain such engines at a constant heavy loading. In some situations, to compensate for sluggish engine response, artificial loads (e.g. resistor banks) are used to keep engine loads high until power produced therewith can be used in an actual operation. Such artificial loading burns relatively more fuel and the total volume of undesirable emissions is higher, but the amount of undesirable nitrous oxide (“NOx”) emissions can be lower. The higher fuel consumption can result in excessive carbon dioxide emissions.

Maximum fuel efficiency is achieved in generator engines (diesel and natural gas powered) at about 90% or higher load capacity. In addition to achieving greater fuel efficiency, some natural gas powered engines used in drilling and drilling related applications are operated at 70% or higher load capacity. This constraint is done to maintain high enough exhaust temperatures to assist catalytic converters in functioning properly.

In many drilling applications, engines are inefficiently employed in order to compensate for transient loading on the generators, which is often a result of drawworks operation. In natural gas powered systems, the throttle response under drawworks loading can be so sluggish it affects industry standard operational speeds. One prior solution has been to maintain engines in standby mode to compensate for sluggish throttle response and cyclical loading Maintaining a generator in standby for these reasons can use excessive fuel and increases the level of nitrous oxide (NOx) and other combustion by-products.

In some systems, the solution to these problems had been to add resistive loads during a drawworks braking cycle, and then transfer the load from the resistor bank to the drawworks during a hoisting cycle. This method of load leveling the engines consumes excessive fuel while the rig operating the drawworks, which produces higher volummes of carbon dioxide and NOx than are necessary.

In several instances, machines or apparatuses on a rig produce power, e.g. drawworks brakes when they are in a braking mode. This power is, in many situations, transferred to a device which wastes the power rather than recovering it for re-use. In one aspect, the power is fed to a resistor apparatus and is dissipated as heat.

In certain cases the power supplied to rig machines is of low quality (e.g., but not limited to, power which does not meet the standards of IEEE Standard 519). The use of this low quality power is undesirable in certain situations and unsuitable for certain critical application, e.g. to run certain instruments, apparatuses, electrical components, sensitive electronic equipment, and computerized devices which can be damaged by low quality power, e.g. such low quality power can cause overheating or can cause standard equipment (e.g. transformers, motors, relays, resistors) to unnecessarily “trip” or activate causing equipment to go off line or causing erroneous signals. In one particular aspect low quality power trip (unnecessarily) a relay that recognizes power drops. Certain low quality power has high harmonic distortions.

In certain cases rig operations have a variety of essential or critical power loads. Certain apparatuses and devices must always have available power and it must be at a certain required level. The failure to provide these essential and critical loads can result in damage to various items and the cessation of rig operations. Also a lowered voltage anywhere on a rig can produce electrical power that must be dealt with.

Harsh environments, generator overload, generator failure, control system anomalies and failures, software crashes, and anomalous power allocation events can result in the failure of a generator, the tripping off of a generator or of multiple generators (e.g. in a domino effect beginning with a first generator and then including additional generators). When a generator goes offline, this can adversely affect on-going operations and, in severe cases, can result in a total power blackout.

Contributing to problems associated with the efficient and effective power allocation to the various power-consuming entitles of a rig is the fact that the power consumed by certain entities is not or cannot be controlled; e.g. the power consumed by certain rig utilities is not limited. In certain aspects, static unchangeable power allocations which are set in stone for certain power-consuming rig entities have resulted in rigs having significantly more power generating capacity or ability (e.g. more power generators) than is ever actually used.

Unless the total power consumed by drill floor equipment is maintained below acceptable levels, generators can overload, shut down or trip off. In the event of a rig or generator going off line (especially suddenly as when one trips), if the actual power usage of equipment, etc. is not limited to an acceptable level quickly enough, other generators can become overloaded and subsequently trip off as a result.

In the oil and gas drilling arts, it is well known to use a drawworks in connection with the rig or derrick to hold and to raise and lower a drill string and associated equipment into and out of the wellbore. Typically, a traveling block having an appropriate hook or other similar assembly is used for the raising and lowering operations. The traveling block is secured in block and tackle fashion to a secured crown block or other limit fixture located at the top of the rig or derrick. The raising and lowering operation of the traveling block is performed by means of a hoist cable or line, one end of which is secured to the rig floor or ground forming a “dead line”, with the other end being secured to the drawworks proper and forming the “fast line”.

The drawworks includes a rotatable cylindrical drum upon which the cable or fast line is wound by means of a suitable prime mover and power assembly. The prime mover is controlled by an operator typically by way of a foot or hand throttle. In connection with the lowering operation, the drawworks is supplied with one or more suitable brakes, also controlled by the operator, usually with hand controls. Generally, the primary brake, which typically is a friction brake of either a band or disk type, is supplemented with an auxiliary brake, such as an eddy current type brake or a magnetic brake. The drawworks may also be provided with an emergency brake which can be activated in the event of a power failure to the eddy current brake or when the traveling block exceeds a maximum safe falling speed.

The brakes can themselves produce power, power that must be dealt with in some way. Typically this power is wasted, e.g. by feeding it to a resistor system for dissipation as heat.

### BRIEF SUMMARY OF THE INVENTION

The present invention, in certain aspects, discloses a power system for generator engines which manages power supplied to the engines and stores power to render engine operation more efficient; in some aspects, to improve or optimize engine loading; and in some particular aspects, to improve or optimize engine response during transient loading (i.e., during abrupt increases in engine load of significantly high percent to cause a decrease in engine speed and generator frequency changes).

The present invention, in certain aspects, discloses a power system for generator engines with a control system including monitors, sensors, and controller(s), e.g. programmable logic controllers or other computerized control(s); monitor(s) for monitoring generator engine exhaust temperatures; power sources, e.g. flywheel apparatus (flywheel, motor, etc.), battery bank(s), and/or resistive power supplies (e.g. resistor bank(s); and monitor(s) for monitoring parameters associated with various components, e.g. bus frequency and voltage.

The present invention, in certain aspects, discloses power systems particularly directed to well service rigs and workover rigs. In such systems which typically have a drawworks as a primary consumer of electric power, power is controlled and supplied by batteries, available utility power, and/or flywheel apparatus power. If not utility power is available a system according to the present invention brings a generator or generators on and off line to charge battery bank(s) and/or to operate the drawworks.

The present invention, in certain aspects, provides a wellbore rig with an electrical motor or motors which are run by power generated by wellbore apparatuses (e.g. by a drawworks brake system or by a lowered voltage anywhere on the rig). In one aspect the motor is a high speed electric motor, e.g. a 3,000 rpm to 10,000 rpm motor. Electrical power generated by braking (which in the past was typically wasted as heat, e.g. via a bank of resistors) is used to run the high speed motor.

Such systems and methods according to the present invention with a motor or motors run by power generated by rig apparatuses are, in certain aspects, used to provide high quality power. This high quality power can be used to “clean” or condition power provided, e.g. by rig generators; or it can be used directly by rig machines and apparatuses.

In certain particular aspects such systems and methods according to the present invention with a motor or motors run by power generated by rig apparatuses are used to make power available continuously on demand, e.g. for satisfying a critical or essential rig power requirement and/or as a back-up power supply.

In certain particular aspects a motor useful in systems and methods according to the present invention employs magnets which are non-surface mounted, magnets which are not glued to a rotor. The magnets are embedded in a rotor.

The present invention, in certain aspects, discloses a rig power control system in which each of a plurality of rig power-consuming entities is a “greedy” power user, i.e. each entity determines and sets its own internal power limit based on its own actual power usage, available power, and the amount of unused power available, without considering the actual power usage or power requirement of any other rig power-consuming entity.

In a particular aspect of such systems, a rig power-consuming entity that determines its own power limit also is able to reduce its own power consumption based on the total power available; thus insuring, e.g. in the event that one generator of a plurality of generators trips off or fails, that total power consumed is reduced so that other generators do not trip off, thereby preventing a power blackout due to one generator after another tripping off.

In certain aspects of systems and methods according to the present invention, each tool, apparatus, etc. independently makes decisions on how to set its power limit. In one aspect a main control system is used; but, alternatively, in another particular aspect no single apparatus of the system (e.g. no single computer system or server) is responsible for all the power control, allocation and budgeting decisions. In one aspect, the present invention provides a distributed power management system employing methods for drill floor tools whose major power consumption is due to variable speed/torque electrical motor(s).

In certain particular aspects, a power-limiting system according to the present invention is used by a tool apparatus to calculate its individual power limit and then the system controls a motor of the tool, etc. to insure that the power limit is not exceeded while it safely holds a load.

In certain aspects, in a distributed power system according to the present invention, each tool, etc. in the system determines how much power is available and how much power other tools, etc. on the system are consuming. For example, on a drilling rig there is a Drawworks, Top Drive, Mud Pumps, and 3 generators, the Drawworks having three 1150 horsepower motors, the Top Drive having one 1150 horsepower motor, and the Mud Pump having two 1150 horsepower motors. Each generator can produce one Megawatt (MW) of power; so, with all generators running, 3 MW of power are available. Some of this power is being used by other services and utilities (lights, office areas, appliances, etc.) so not all of this power is available for the drill floor tools. In one aspect, it is not important for the tools, etc. to know where the power is being used, but it the tools are able to determine the maximum power capacity (the total number of generators on-line times the maximum capacity for each generator) and how much power is actually being consumed. The difference between the total power capacity and the actual consumption is the unused or available capacity.

Each tool, etc. is able to determine the available capacity—each tool sums the total capacity of each on-line generator and subtracts the actual power output from each generator. Each tool determines its own power output. In the distributed approach, each tool sets its own internal power limit to the lesser of the sum of its own power requirements plus the total available capacity or its maximum power needs.

In certain particular aspects of systems and methods of the present invention, a rig has a drawworks having a rotatable drum on which a line is wound, wherein the drawworks and the line are used for facilitating movement of a load suspended on the line. A drawworks control system monitors and controls the drawworks. A brake arrangement is connected to the rotatable drum for limiting the rotation of the rotatable drum and at least one drawworks motor (electrically powered) is connected to the rotatable drum for driving the rotatable drum.

When the rotation of the rotatable drum is in a hoisting direction or is stationary, the drawworks control system provides a disabling signal for commencing a gradual release of the brake arrangement from the rotatable drum. When the rotation of the rotatable drum is in a lowering direction, the drawworks control system provides an enabling signal for engaging the brake arrangement to limit rotation of the rotatable drum. The reverse rotation of the drum or of the drawworks motor produces power. This power is converted into electrical power by a drive and this electrical power is fed to a motor (or motors) which is run continuously to supply power as needed on the rig. In one aspect this power accelerates a high speed motor to a much higher speed than base free-wheeling speed.

When the drawworks motor is a direct current motor a silicon controlled rectifier circuit is used. Alternatively, systems according to the present invention are used with an alternating current drawworks motor.

Accordingly, the present invention includes features and advantages which are believed to enable it to advance rig power reclamation technology. Characteristics and advantages of the present invention described above and additional features and benefits will be readily apparent to those skilled in the art upon consideration of the following detailed description of preferred embodiments and referring to the accompanying drawings.

What follows are some of, but not all, the objects of this invention. In addition to the specific objects stated below for at least certain preferred embodiments of the invention, there are other objects and purposes which will be readily apparent to one of skill in this art who has the benefit of this invention's teachings and disclosures. It is, therefore, an object of at least certain preferred embodiments of the present invention to provide the embodiments and aspects listed above and:

New, useful, unique, efficient, nonobvious power systems for a generator engine and, in certain aspects, such systems which contribute to the control of undesirable emissions from such engines.

New, useful, unique, efficient, nonobvious power methods and systems for rigs used for wellbore operations;

Such systems and methods for efficiently recovering power generated on a rig;

Such systems and methods for using power recovered on a rig;

Such systems and methods for providing high quality power on a rig;

Such systems according to the present invention in which each rig power-consuming entity determines its own power limit;

Such systems in which each power-consuming entity can reduce its power usage in response to a lowered power limit or reduced power availability; and

New useful, unique, efficient, nonobvious methods for implementing and using such systems.

Certain embodiments of this invention are not limited to any particular individual feature disclosed here, but include combinations of them distinguished from the prior art in their structures, functions, and/or results achieved. Features of the invention have been broadly described so that the detailed descriptions that follow may be better understood, and in order that the contributions of this invention to the arts may be better appreciated. There are, of course, additional aspects of the invention described below and which may be included in the subject matter of this invention. Those skilled in the art who have the benefit of this invention, its teachings, and suggestions will appreciate that the conceptions of this disclosure may be used as a creative basis for designing other structures, methods and systems for carrying out and practicing the present invention. This invention includes any legally equivalent devices or methods which do not depart from the spirit and scope of the present invention.

The present invention recognizes and addresses the problems and needs in this area and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of certain preferred embodiments, given for the purpose of disclosure, when taken in conjunction with the accompanying drawings. The detail in these descriptions is not intended to thwart this patent's object to claim this invention no matter how others may later attempt to disguise it by variations in form, changes, or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly from a cursory inspection or review the nature and general area of the disclosure of this invention. The Abstract is neither intended to define the invention, which is done by the claims, nor is it intended to be limiting of the scope of the invention in any way or of the claims in any way.

It will be understood that the various embodiments of the present invention may include one, some, or all of the disclosed, described, and/or enumerated improvements and/or technical advantages and/or elements in claims to this invention.

### BRIEF DESCRIPTION OF THE SEVERAL VIEWS OF THE DRAWING

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or legally equivalent embodiments.

FIG. 1 is a schematic diagram of a drilling rig and traveling block assembly including a power system according to the present invention.

FIG. 2 is a block diagram of the rig and control system of FIG. 1.

FIG. 3A is a schematic diagram of a drilling rig and traveling block assembly including a drawworks control system according to the present invention.

FIG. 3B is a schematic diagram of a drilling rig and traveling block assembly including a drawworks control system according to the present invention.

FIG. 4 is a block diagram of the drawworks and drawworks control system of FIG. 3 including a signal flow diagram.

FIG. 5A is a graphic representation of power usage on a rig.

FIG. 5B is a graphic representation of power usage on a rig.

FIG. 5C is a graphic representation of power usage on a rig.

FIG. 6 is a schematic vies of a system according to the present invention.

FIG. 7 is a schematic vies of a system according to the present invention.

FIG. 8 is a schematic vies of a system according to the present invention.

FIG. 9 is a schematic view of a motor useful in certain embodiments of the present invention.

Presently preferred embodiments of the invention are shown in the above-identified figures and described in detail below. It should be understood that the appended drawings and description herein are of preferred embodiments and are not intended to limit the invention or the appended claims. On the contrary, the intention is to cover all modifications, equivalents and alternatives falling within the spirit and scope of the invention as defined by the appended claims. In showing and describing the preferred embodiments, like or identical reference numerals are used to identify common or similar elements. The figures are not necessarily to scale and certain features and certain views of the figures may be shown exaggerated in scale or in schematic in the interest of clarity and conciseness.

As used herein and throughout all the various portions (and headings) of this patent, the terms “invention”, “present invention” and variations thereof mean one or more embodiment, and are not intended to mean the claimed invention of any particular appended claim(s) or all of the appended claims. Accordingly, the subject or topic of each such reference is not automatically or necessarily part of, or required by, any particular claim(s) merely because of such reference. So long as they are not mutually exclusive or contradictory any aspect or feature or combination of aspects or features of any embodiment disclosed herein may be used in any other embodiment disclosed herein.

### DETAILED DESCRIPTION OF THE INVENTION

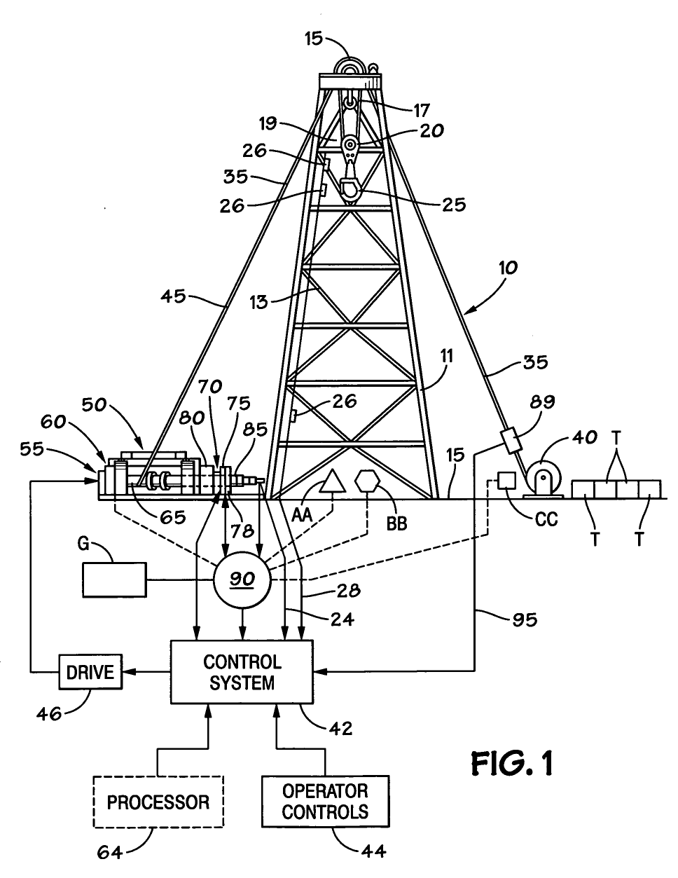

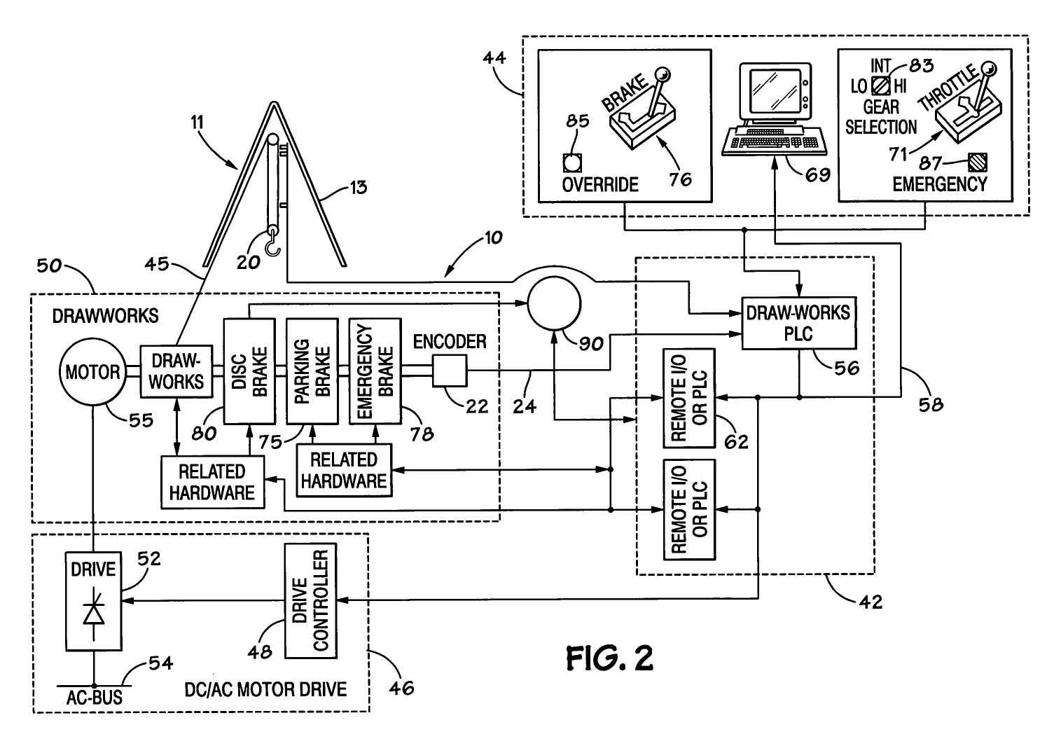

Referring to FIGS. 1 and 2, diagrams of a drawworks control system according to the present invention connected to a drilling rig and including a traveling block is illustrated. A system 10 according to the present invention has a derrick 11 that supports, at its upper end, a crown block 15. Suspended by a rope arrangement 17 from the crown block 15 is a traveling block 20, or load bearing part, for supporting a hook structure 25.

A hoisting line 30 is securely fixed at one end to ground by means of a dead line 35 and a dead line anchor 40. The other end of the hoisting line 30 forms a fast line 45 attached to drawworks 50. The drawworks 50 includes one or more electrical motors 55 and a transmission 60 connected to a cylindrical rotatable drum 65 for wrapping and unwrapping the fast line 45 as required for operation of the associated crown block 15 and traveling block 20. The rotatable drum 65 is also referred to as a winding drum or a hoisting drum. A brake arrangement 70 includes a primary friction brake 80, typically a band type brake or disk brake, an auxiliary brake 75, such as an eddy current type brake or a magnetic brake, and an emergency brake 78. The brake arrangement 70 is connected to the drawworks 50 by driveshaft 85 of the drawworks 50. The brake arrangement 70 is typically actuated either hydraulically or pneumatically, using, for example, a pneumatic cylinder that is engaged by rig air pressure by way of an electronically actuated air valve.

A load sensing device, such as a strain gage 89 is affixed to the dead line 35, and produces an electrical signal on output line 95 representative of the tension in dead line 35 and consequently, the load carried by traveling block 20. Various tension measuring devices may be employed to indicate the tension conditions on the line 30. The actual hook load is calculated using the strain gage 90 input in conjunction with the number of lines strung and a calibration factor. Alternatively, a conventional load cell, hydraulic tension transducers or other load measuring device may be associated with derrick 10 to provide an electrical output load signal representative of the load carried by traveling block 20.

A measuring device, such as an encoder 22, for example, is affixed to the driveshaft 85. An electrical output signal representative of the rotation of the rotatable drum 65 is produced on line 24 from encoder 22 as drum 65 rotates to pay out or wind up fast line 45 as the traveling block 20 descends or rises. The frequency of the encoder is used to measure the velocity of the traveling block 20 movement, typically, by calculating the actual drum 65 speed and ultimately the traveling block 20 speed based on lines strung, the diameter of the drum 65, the number of line wraps and the line size. Alternatively, the velocity of the traveling block 20 movement is calculated from the change in the vertical position of the traveling block 20.

A plurality of positioning sensors, such as proximity switches 26, are used to determine the position of the traveling block 20. An electrical output signal from the proximity switches 26 representative of the position of the traveling block 20 will be produced on line 28 and the actual position of the traveling block 20 is calculated based on the drum 65 diameter, the line 30 size and number of lines, the line stretch, and the weight-on-bit (WOB) which effects line stretch.

A drawworks control system 42 receives electrical output signals from the proximity switches 26, the encoder 22 and the strain gage 89, and is connected to the brake arrangement 70. The drawworks control system 42 is connected to a driller or operator control center 44 located on or near the derrick 11. The drawworks control system 42 is also connected to the electrical motor 55 through a drive 46. The drawworks motor 55 is an alternating current (AC) motor or a direct current (DC) motor and the drive 46 is an AC or a DC drive respectively. The drive 46, for example, includes a controller 48, such as a programmable logic controller (PLC) and one or more power electronic switches 52 connected to an AC bus 54. For example, the drive for a DC motor includes an electronic switch 52 such as a silicon controlled rectifier for AC/DC conversion.

The drawworks control system 42 can include a programmable logic controller (the drawworks PLC 156) and is interfaced with the drive 46 using, for example, a serial communication connection 58 such as, for example, an optical linkage and/or hard-wired linkage. Two or more remote programmable logic controller (PLC) input/output (I/O) units 62 are used to control the transmission 60 and brake arrangement 70 of the drawworks 50. Alternatively, a processor 64 is also connected to the drawworks control system 53 for providing operating parameters and calculated values during the performance of various drilling rig operations. The processor 64 is a conventional signal processor, such as a general-purpose digital computer.

The drawworks control system 42 provides a velocity command and a torque command signal to the drive controller 46. The drive 46 uses regeneration when necessary to maintain the velocity considering power system limit requirements. Each drive 46 provides the motor velocity (with a signed integer to indicate the direction of movement) and the torque level (with a signed integer to indicate the direction of movement) feedback to the drawworks control system 42. The drive controller 48 also provides flags to the drawworks control system 42 to indicate various alarm conditions of the drive 46 and the motor 55.

An operator control center 44 or man-machine interface is, in certain aspects, a console including throttle control joysticks, switches, and an industrial processor driven monitor 69 wherein the operator or driller can set and control certain operational parameters. For example, the operator controls the direction and velocity of the traveling block 20 movement using a movement control joystick 71 installed at the operator console. The travel of the movement control joystick 71 produces a linear analog electrical input signal provided to the drawworks PLC 56 of the drawworks control system 42.

Optionally, an auxiliary apparatus is used to control the friction brake 80 directly as a backup to the drawworks control system 42, alternatively, bypassing the drawworks control system 42. For example, a brake control joystick 76 provides an auxiliary means to directly control the application of the disk brake 80 when necessary.

Through the use of various switches and/or levers at the operator control center 44, the operator selects operational parameters, such as, for example, a gear selection switch 83, an override switch 85 and an emergency shutoff switch 87. Alternatively, the monitor is, for example, a typical industrial computer including a touch-screen monitor mounted in front of the operator as a part of the man-machine interface. The operator monitors and sets system parameters and operational parameters including; the number of active drives, the active gear selected, the traveling block position, the block speed, the hook load, the upper and lower position set points, the maximum traveling block velocity set point, the percentage of control disk brake applied, the parked condition, and any abnormal or alarm condition flags or messages. The operator can modify the upper and lower traveling block position set points, the maximum traveling block velocity set points and acknowledge certain alarms.

For hoisting the traveling block 20, the operator, for example, sets the movement control joystick in the hoisting position and the traveling block 20 and any associated equipment or suspended load accelerates upward until the traveling block reaches and maintains the velocity set by the position of the joystick set by the operator. For lowering the traveling block 20, the operator, for example, sets the movement control joystick in the lowering position and the traveling block 20 and any associated equipment or suspended load accelerates downward (driven by the electrical motor 55, if required) to reach and maintain the velocity set by the position of the movement control joystick.

In one typical operation, raising the traveling block 20 and the load attached thereto, the motors 55 associated with the drawworks 50 are activated to wind fast line 45 onto rotatable drum 65. Conversely, when the traveling block 20 is lowered, electrical motors 55 are disengaged and rotatable drum 65 is rotated so as to pay out the fast line 45 under the slowing effect of auxiliary brake 75. In the event that a faster downward travel speed is desired, the braking action of the brake arrangement 70 is reduced or de-energized completely. On the other hand, if the downward travel of the block 20 is to be slowed, the braking action of brake 75 is increasingly energized. In typical operation, the primary friction brake 80 may be operated by a primary brake operating lever.

In the system of the present invention, regenerative or dynamic braking of the one or more electric motors 55, controlled by the drive 120, can be used as the primary method of braking during all modes of movement and velocity control, and stopping of the traveling block 20. The drawworks control system 42 provides a velocity command signal to the drive 46 for hoisting, lowering and stopping, and the drive 46 maintains the velocity according to the velocity command signal provided using regeneration or dynamic braking when necessary. The friction brake 80 is used to back up or compliment this retarding force of regeneration and to hold the traveling block 20 and load in the parking mode.

Power produced by the brake arrangement 70 provides electrical power to run a motor 90.

In certain aspects the motor 90 is an electrically-powered high-speed motor. In one particular aspect, magnets used in the motor 90 are not glued in place but are embedded in the motor's rotor.

The high-speed motor 90 can be used to run rig apparatuses and devices, e.g. the drawworks motors, and items AA, BB, and CC, shown schematically (indicated by dash-dot lines) which may be, but are not limited to, pumps motors, rotaries, top drives, racking systems, and HPU's.

In certain aspects, the motor 90 runs a generator (or generators) G that produces electrical power. This power can be used anywhere on the rig. For example, this power can be used to condition or “clean” power supplied by rig generators T.

In certain aspects the motor 90 (or the motor-90-generator-G combination) is continuously operational so that its power is available on demand in a critical or emergency situation.

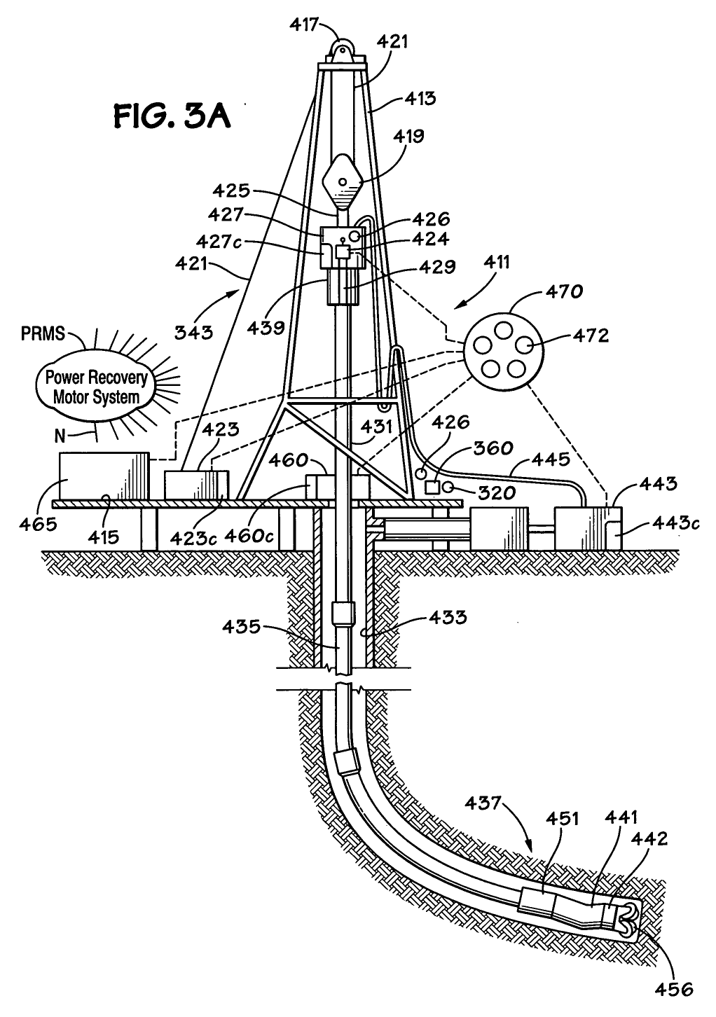

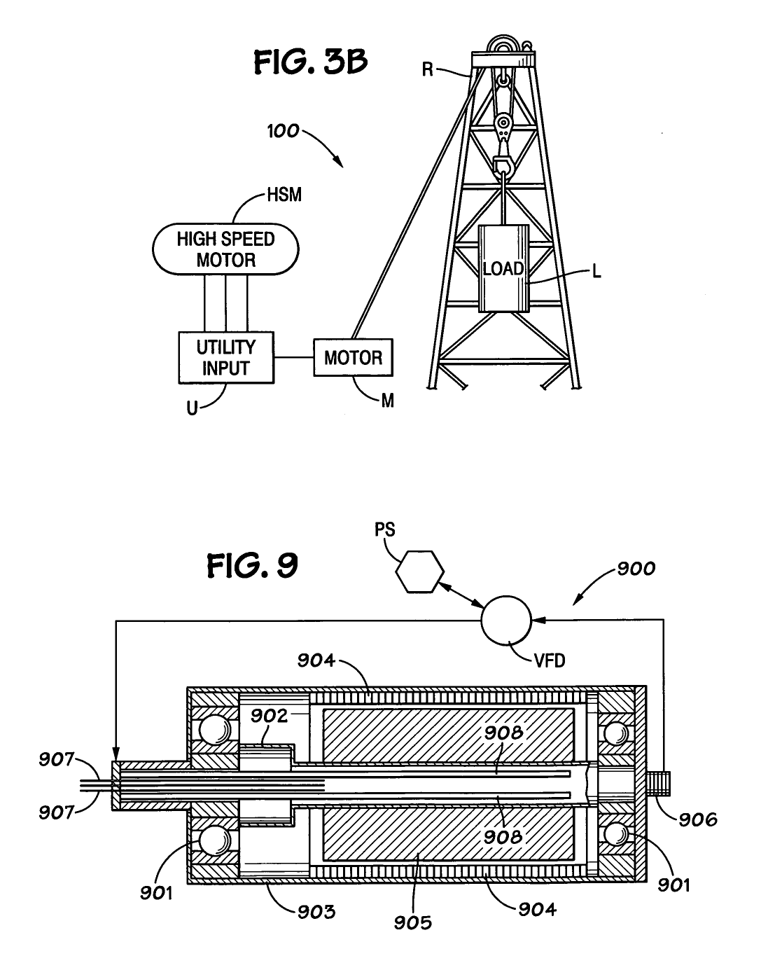

Referring now to FIG. 3A, a system according to the present invention has a drilling rig 41 depicted schematically as a land rig, but other rigs (e.g., offshore rigs and platforms, jack-up rigs, semisubmersibles, drill ships, and the like) are within the scope of the present invention. In conjunction with an operator interface, e.g. an interface 320, a control system 360 controls operations of the rig. The rig 411 includes a derrick 413 that is supported on the ground above a rig floor 415. The rig 411 includes lifting apparatus, a crown block 417 mounted to derrick 413 and a traveling block 419 interconnected by a cable 421 that is driven by a drawworks 423 (with an electrically powered motor or motors) to control the upward and downward movement of the traveling block 419. Traveling block 419 carries a hook 425 from which is suspended a top drive system 427 which includes a variable frequency drive controller 426, a motor (or motors) 424, electrically powered, and a drive shaft 429. A power swivel may be used instead of a top drive. The top drive system 427 rotates a drillstring 431 to which the drive shaft 429 is connected in a wellbore 433. The top drive system 427 can be operated to rotate the drillstring 431 in either direction. According to an embodiment of the present invention, the drillstring 431 is coupled to the top drive system 427 through an instrumented sub 439 which includes sensors that provide drilling parameter information.

The drillstring 431 may be any typical drillstring and, in one aspect, includes a plurality of interconnected sections of drill pipe 435 a bottom hole assembly (BHA) 437, which can include stabilizers, drill collars, and/or an apparatus or device, in one aspect, a suite of measurement while drilling (MWD) instruments including a steering tool 451 to provide bit face angle information. Optionally a bent sub 441 is used with a downhole or mud motor 442 and a bit 456, connected to the BHA 437. As is well known, the face angle of the bit 456 can be controlled in azimuth and pitch during drilling.

Drilling fluid is delivered to the drillstring 431 by mud pumps 443 which have electrically-powered motors through a mud hose 445. The drillstring 431 is rotated within bore hole 433 by the top drive system 427. During sliding drilling, the drillstring 431 is held in place by top drive system 427 while the bit 456 is rotated by the mud motor 142, which is supplied with drilling fluid by the mud pumps 443. The driller can operate top drive system 427 to change the face angle of the bit 456. The cuttings produced as the bit drills into the earth are carried out of bore hole 433 by drilling mud supplied by the mud pumps 443.

Rig utilities are shown collectively and schematically as the block 465. A power system 470 with generators 472 (and associated rectifiers as needed) provides power to the various power-consuming items on the rig (as shown by dotted lines). Each of the items 423, 427, 443 and 460 has its own single board computer 423c, 427c, 443c and 460c respectively. Although a top drive rig is illustrated, it is, optionally, within the scope of the present invention, for the present invention to be used in connection with a rotary system 460 in which a rotary table and kelly are used to rotate the drillstring (or with a rotary system above).

The single board computers 423c, 427c, 443c and 460c each have programmable media programmed so that each separate computer calculates a power limit for its particular tool or system. A “power limit” is the maximum power consumption for that tool or system (in one particular aspect, a maximum beyond which the tool or system will shut down). The computer is programmed to perform the power limit calculations.

Each single board computer controls its respective tool or system. Optionally a main control system is in communication with each single board computer.

In one aspect, each single board computer is programmed to calculate a power limit for its particular tool or system without taking into account the power usage or power requirements of any other power-consuming entity. In one aspect each single tool and system attempts to account for and deal with a total system power deficit or reduction. In one aspect, since each tool and system ignores other systems, and each tool and system tries to deal with a power deficit or reduction, blackouts will not occur since each tool or system will automatically reduce its own power consumption when there is a power deficit or power reduction.

Thus, for example, in the power system 470 with the multiple individual electric power generators 472, when a first generator fails, shuts down, or otherwise goes off line, each tool's and each system's single board computer almost instantaneously takes into account the reduction in available power in setting its own power limit and reduces its power limit accordingly. With each single board computer doing this, there is no increased load on other generators that are still active and, thus, no additional generators trip off due to an excessive load demand. Each single board computer is also programmed to then reduce its tool's power consumption to a level at or below the newly-calculated power limit.

Optionally, the system of FIG. 3A has a power recovery motor system PRMS according to the present invention which is any system according to the present invention with a motor or motors for recovering power generated by an apparatus or machine on the rig.

FIG. 3B illustrates a system 100 according to the present invention in which a motor M is used to raise and lower a load L in a rig R. Power is supplied to the motor M from a utility input U (e.g. one or more power generators on the rig or a local utility).

When the load L is lowered, the descent of the load L turns the motor's shaft and thereby the motor generates electricity. This generated electricity is transmitted to a high speed motor HSM (e.g., but not limited to, via the utility input) or is transmitted directly from the motor M to the high speed motor HSM. The shaft of the high speed motor HSM is then rotated at a high speed, e.g. 7200 rpm, and this rotative power is then available to run another apparatus. The power will be available while the shaft of the high speed motor HSM is rotating. In one aspect it might take such a shaft a number of minutes, N, to cease rotation and, for N minutes, the rotative power is available. In one particular aspect N is about 45 minutes. In one aspect, particularly when short cycling a rig load up and down, the load can be re-raised by the high speed motor HSM which has been previously powered by the electrical power produced by the lowering of a load.

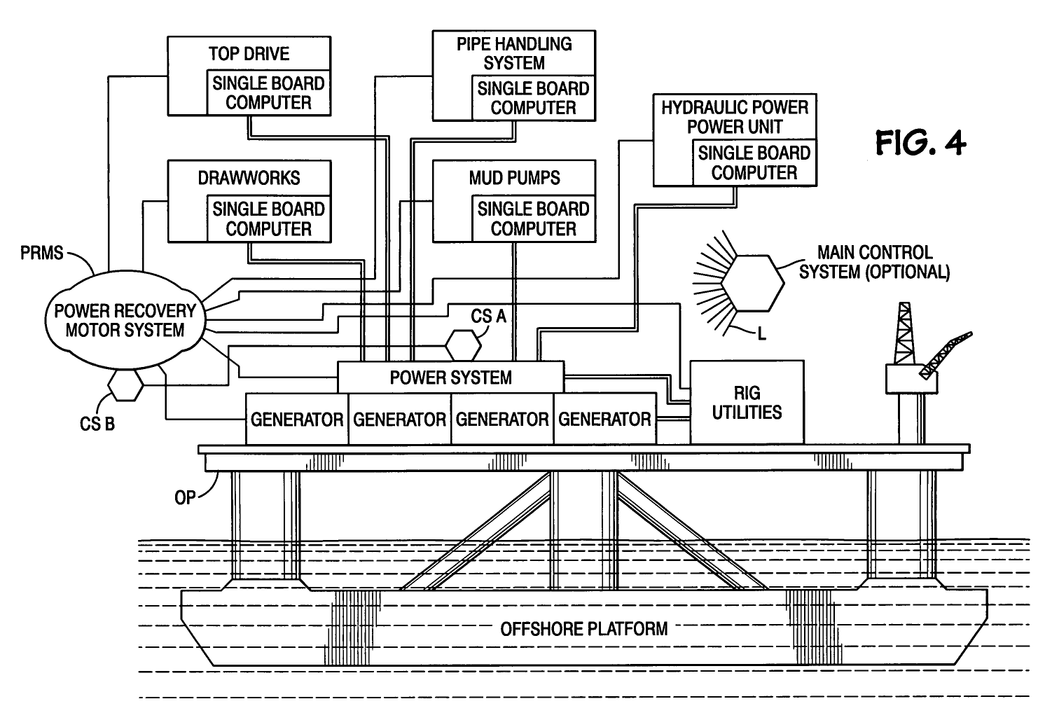

FIG. 4 shows an offshore platform OP which has a power system with a plurality of generator systems that produce electrical power for a variety of tools and systems. Each tool or system has its own single board computer which monitors total power available from the power system and which computes and implements a power limit for its respective tool or system with a method according to the present invention.

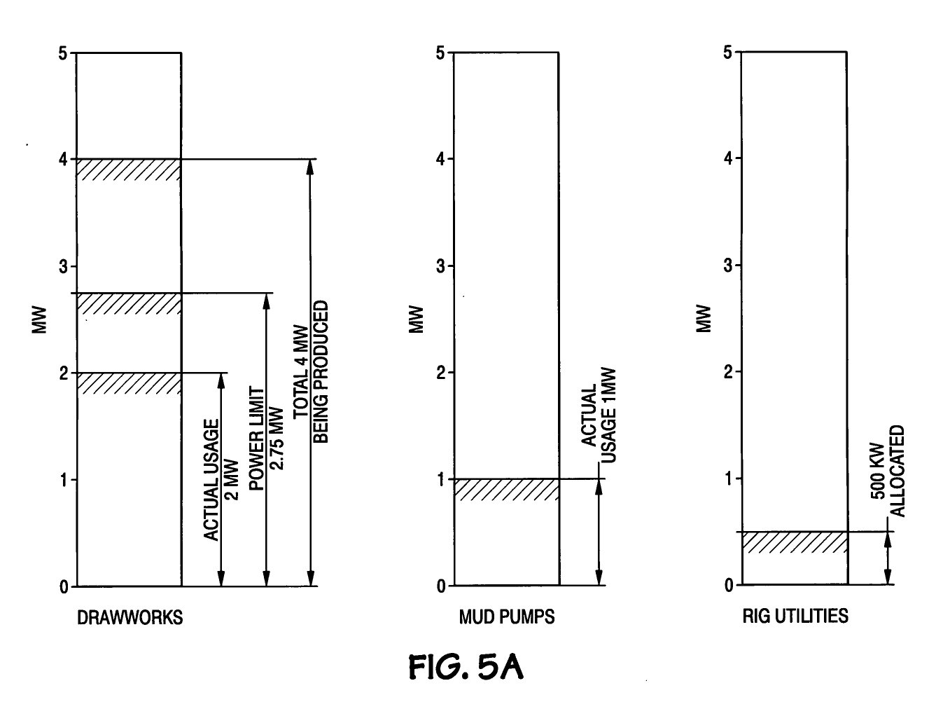

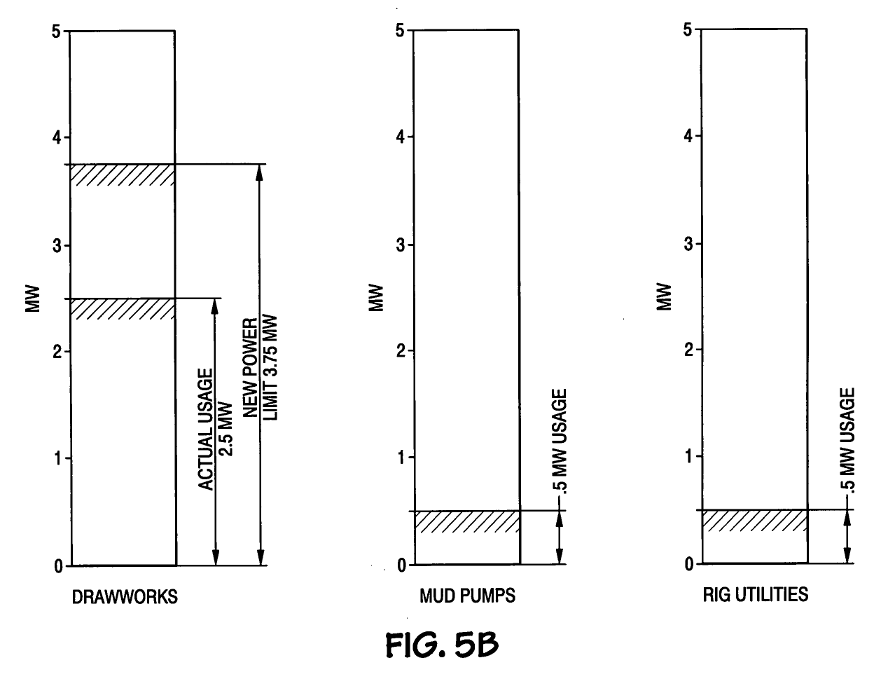

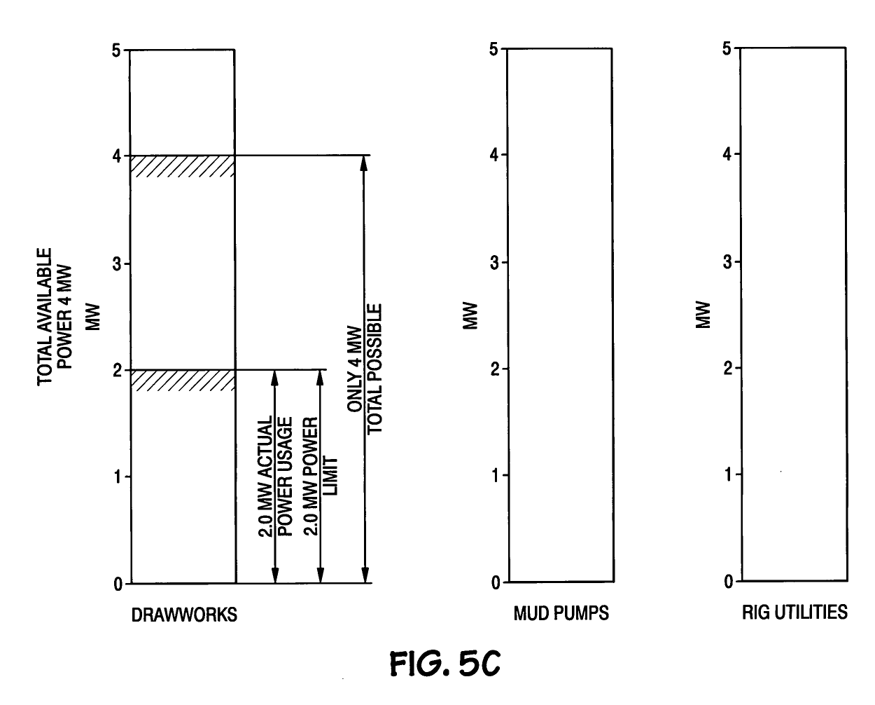

FIGS. 5A-5C show an adaptive allocation of power according to the present invention to several power consuming entities on a rig at initial power levels and when the total available power decreases. FIG. 5A illustrates graphically a power limit and actual power usage for a drawworks, mud pumps, and rig utilities. In this situation there are five generators, each able to produce 1 Megawatt of power. A static power allocation for the rig utilities is assumed to be 500 kilowatts. 1 Megawatt is being used by the mud pumps. The drawworks is, initially, using 2 Megawatts.

A single board computer on the drawworks knows that: there are five generators on line with a total capacity of 5 Megawatts (maximum possible output); the drawworks is presently using 2 Megawatts; and that, e.g., at present only 4 Megawatts of power are actually being generated by the five generators. Thus the single board computer calculates that there is 1 spare Megawatt of power.

As shown in FIG. 5A, the single board computer has calculated a power limit for the drawworks of 2.75 Megawatts. (2 MW being used+power preference factor×1 MW available) “Power preference factor” is a preselected number used to establish priority for power among different tools and systems—each one with its own power preference factor and their total can be less than, equal to, or greater than 1). Assuming a power preference factor of 0.25, the power limit of 2.75 is established. In ongoing operations that follow, the single board computer sees an actual usage of 2.5 Megawatts (see FIG. 5B) and then calculates a power limit for the drawworks of 3.75 Megawatts. Then one of the generators trips off or fails so that only a total of 4 Megawatts can be generated (see FIG. 5C). At this point, this moment, the total rig power consumption is 4.5 MW (See FIG. 5B) (consumption of power by drawworks, mud pumps, rig utilities). The single board computer of the drawworks sees a 0.5 Megawatt deficit. This drawworks single board computer immediately attempts to compensate for the entire 0.5 Megawatt deficit by itself. It knows the drawworks is presently using 2.5 Megawatts, but this level is instantaneously lowered by the drawworks single board computer (in response to the power deficit indication) and the single board computer re-sets the drawworks power limit to 2 Megawatts. At this point the drawworks control system only allows the drawworks to use 2.0 Megawatts of power.

In another example a drilling rig has a Drawworks, a Top Drive System, a Mud Pump System with multiple Mud Pumps, and three generators. The drawworks has three 1150 horsepower motors, the Top Drive has one 1150 horsepower motor, and the Mud Pump has two 1150 horsepower motors—all motors electrically powered. Each generator can produce one Megawatt (MW) of power, so, with all generators running, a maximum of 3 MW of power are available.

TABLE I

| | total capacity | current output | available capacity |
|---|---|---|---|
| Gen 1 | 1000 | 300 | 700 |
| Gen 2 | 1000 | 300 | 700 |
| Gen 3 | 1000 | 300 | 700 |
| Total | 3000 | 900 | 2100 |

(capacities in kilowatts)

| | | | | sys power | |
|---|---|---|---|---|---|
| | tool | tool | current | limit | power limit |
| | limit (HP) | limit (kW) | output | calculation | used |
| Drawworks | 3450 | 2573 | 300 | 2400 | 2400 |
| Top Drive | 1150 | 858 | 300 | 2400 | 858 |
| Mud Pumps | 2300 | 1715 | 100 | 2200 | 1715 |
| Total | 6900 | 5145 | 700 | 7000 | 4973 |

With all three generators on line and at that moment producing 300 kW of power each, the total available capacity is 3 MW (3×300 kW)=2.1 MW. The Mud Pumps are running and using 100 kW of power; and thus the single board computer for the Mud Pumps sets an internal power limit to 2.1 MW+100 kW=2.2 MW; but, since the maximum allowed horsepower is 2300 horsepower, it uses a limit of 1.7 kW. The Top Drive is using 300 kW of power, and its single board computer determines a maximum power limit of 2.1 MW+300 kW=2.4 MW; but since the maximum allowed power for the Top Drive is 1150 horsepower or 858 kW it sets its internal power limit to 858 kW. Similarly, with the Drawworks consuming 300 kW of power, it sets its power limit to 2.1 MW+300 kW=2.4 MW. Since its maximum allowed horsepower is 3450 horsepower (2.57 MW), it uses 2.4 kW for its power limit.

In a similar situation as above, but with only one of the generators on line with an actual power output of 700 kW, power limits (calculated and used) are as follows.

TABLE II

| | total capacity | current output | available capacity |
|---|---|---|---|
| Gen 1 | 1000 | 700 | 300 |
| Gen 2 | 0 | 0 | 0 |
| Gen 3 | 0 | 0 | 0 |
| Total | 1000 | 700 | 300 |

(capacities in kilowatts)

| | | | | sys power | |
|---|---|---|---|---|---|
| | tool | tool | current | limit | power limit |
| | limit (HP) | limit (kW) | output | calculation | used |
| Drawworks | 3450 | 2573 | 300 | 600 | 600 |
| Top Drive | 1150 | 858 | 300 | 600 | 600 |
| Mud Pumps | 2300 | 1715 | 100 | 400 | 400 |
| Total | 6900 | 5145 | 700 | 1600 | 1600 |

In both of the cases described above the total power limits for all the tools are greater than the actual capacity of the generators. This is a “greedy” approach that allows each tool to assume the entire reserve capacity could be allocated to it. In reality this is effective since the power outputs are dynamically updated values (updated, e.g., fifty times a second) and as one tool or entity starts to use more power the other tools power budgets are reduced because the total available power is reduced.

There may be a lag between how rapidly a tool can start consuming power and how quickly other tools reduce their total power available calculation. Since only, typically, a Top Drive and Drawworks generally have sudden increases in power consumption, and in real rig applications they do not usually consume large amounts of power simultaneously, such a lag is not a problem. The Drawworks is a large consumer of power while hoisting rapidly when the Top Drive is, or should be, idle and the Top Drive is a large consumer of power while drilling ahead while the Drawworks is lowering very slowly and actually regenerating power. If it turns out that the power data has sufficient lag that allowing each tool to greedily allocate all reserve power to itself causes overpower conditions. It would be possible to add a power preference factor to each tool for the percentage of available power it will allocate to itself. In one such case, power limit calculations for the first example described above would be:

TABLE III

| | total | current | available |
|---|---|---|---|
| | capacity | output | capacity |
| Gen 1 | 1000 | 300 | 700 |
| Gen 2 | 1000 | 300 | 700 |
| Gen 3 | 1000 | 300 | 700 |
| Total | 3000 | 900 | 2100 |

(capacities in kilowatts)

| | | tool | | | sys | power |
|---|---|---|---|---|---|---|
| | tool limit | limit | current | pref | power limit | limit |
| | (HP) | (kW) | output | factor | calculation | used |
| Drawworks | 3450 | 2573 | 300 | 50 | 1350 | 1350 |
| Top Drive | 1150 | 858 | 300 | 60 | 1560 | 858 |
| Mud Pumps | 2300 | 1715 | 100 | 90 | 1990 | 1715 |
| Total | 6900 | 5145 | 700 | 200 | 4900 | 3923 |

(“pref factor” is power preference factor)

In one aspect the power preferred factors total 100 and the total power limit used by all tools would never exceeds the total capacity of the system. In situations in which this is unnecessarily restrictive as seen in the example below, the total power available is 3 MW but the allocated capacity is only 2.7 MW, and thus the total of the power preference factors can, according to the present invention, as desired exceed 100%.

TABLE IV

| | total | current | available |
|---|---|---|---|
| | capacity | output | capacity |
| Gen 1 | 1000 | 300 | 700 |
| Gen 2 | 1000 | 300 | 700 |
| Gen 3 | 1000 | 300 | 700 |
| Total | 3000 | 900 | 2100 |

(capacities in kilowatts)

| | | tool | | | sys | power |
|---|---|---|---|---|---|---|
| | tool limit | limit | current | pref | power limit | limit |
| | (HP) | (kW) | output | factor | calculation | used |
| Drawworks | 3450 | 2573 | 300 | 25 | 825 | 825 |
| Top Drive | 1150 | 858 | 300 | 30 | 930 | 858 |
| Mud Pumps | 2300 | 1715 | 100 | 45 | 1045 | 1045 |
| Total | 6900 | 5145 | 700 | 100 | 2800 | 2728 |

In certain aspects each tool is able to ultimately use all power available to the system up to its tool limit, but the power allocation would be asymptotic instead of immediate. The first two examples (see TABLES I, II) are equivalent to having a 100% power preference factor for each tool.

In a continuation of the above examples, in one case a generator drops offline. Just prior to this the system is running along with the following power situation:

TABLE V

| | total | current | available |
|---|---|---|---|
| | capacity | output | capacity |
| Gen 1 | 1000 | 550 | 450 |
| Gen 2 | 1000 | 550 | 450 |
| Gen 3 | 0 | 0 | 0 |
| Total | 2000 | 1100 | 900 |

(capacities in kilowatts)

| | | tool | | | sys | power |
|---|---|---|---|---|---|---|
| | tool limit | limit | current | pref | power limit | limit |
| | (HP) | (kW) | output | factor | calculation | used |
| Drawworks | 3450 | 2573 | 400 | 25 | 625 | 625 |
| Top Drive | 1150 | 858 | 300 | 30 | 570 | 570 |
| Mud Pumps | 2300 | 1715 | 100 | 45 | 505 | 505 |
| Total | 6900 | 5145 | 800 | 100 | 1700 | 1700 |

The tools are consuming 800 kW, the rest of the rig is using 300 kW for a total consumption of 1.1 MW. Then Gen 2 trips offline.

TABLE VI

| | total | current | available |
|---|---|---|---|
| | capacity | output | capacity |
| Gen 1 | 1000 | 550 | 450 |
| Gen 2 | 0 | 550 | □550 |
| Gen 3 | 0 | 0 | 0 |
| Total | 1000 | 1100 | □100 |

(capacities in kilowatts)

| | | tool | | | sys | power |
|---|---|---|---|---|---|---|
| | tool limit | limit | current | pref | power limit | limit |
| | (HP) | (kW) | output | factor | calculation | used |
| Drawworks | 3450 | 2573 | 400 | 25 | 375 | 375 |
| Top Drive | 1150 | 858 | 300 | 30 | 270 | 270 |
| Mud Pumps | 2300 | 1715 | 100 | 45 | 55 | 55 |
| Total | 6900 | 5145 | 800 | 100 | 700 | 700 |

Suddenly the total available capacity is negative. This negative available capacity causes each tool almost instantaneously to calculate and use a power limit lower than its current consumption, reducing the total system power requirement exactly as needed to meet the power available (300 kW used elsewhere+700 kW for the tools=1 MW).

As soon as the data from the offline generator gets updated the calculation is as follows:

TABLE VII

| | total | current | available |
|---|---|---|---|
| | capacity | output | capacity |
| Gen 1 | 1000 | 1000 | 0 |
| Gen 2 | 0 | 0 | 0 |
| Gen 3 | 0 | 0 | 0 |
| Total | 1000 | 1000 | 0 |

(capacities in kilowatts)

| | | tool | | | sys | power |
|---|---|---|---|---|---|---|
| | tool limit | limit | current | pref | power limit | limit |
| | (HP) | (kW) | output | factor | calculation | used |
| Drawworks | 3450 | 2573 | 375 | 25 | 375 | 375 |
| Top Drive | 1150 | 858 | 270 | 30 | 270 | 270 |
| Mud Pumps | 2300 | 1715 | 55 | 45 | 55 | 55 |
| Total | 6900 | 5145 | 700 | 100 | 700 | 700 |

If the power preference factors total more than 100% then the system will over respond to an actual generator trip, but then gradually increase the power limits until the full power consumption is used.

In certain aspects, a digital filter is added to ramp increases in the power limit used per tool and to allow instantaneous drops in the limit.

So that a power limit for a particular tool does not become zero, the tool's single board computer includes a preprogrammed minimum power limit.

If the “greedy” approach fails, in another method according to the present invention each tool calculates the actual power usage by each of the other tools (and itself), and allocates the remaining power budget accordingly. This provides a response to any change in the power condition perfectly, but each tool must be reading information, e.g. speed/torque feedbacks, from every tool system, and apparatus on the network. Once each tool has established its power limit, it safely sets the internal speed and torque limits of its motor to operate within the power limit and remain safe. For tools with electrically powered motors, each tool calculates a speed and torque limit based on its static logic and operator requests. The tool's single board computer's software handles the case where the drive is not moving as fast as requested, a result of power limiting. The electrical power consumption of a given motor can be calculated by the current speed and torque outputs:

P=ωτ/ε

Where P is the power, ε is an efficiency factor for the motor (e.g. typically 85%), ω is the angular velocity, and τ the torque output.

The power usage of a motor can be limited by controlling the motor speed, but sudden reductions in power output would not be possible, since it is not possible to instantly lower the speed of a rotating system. It is, however, possible to lower the torque output of a motor nearly instantaneously. Thus for a given power limit, PL, and the actual angular velocity from the motor, a torque limit can be calculated to stay within the power limit:

τ_{L}=εP_{L}/ω

Where τ_{L} is the power torque limit and other values are as above. If the motor is not rotating (ω=0) then the torque limit due to the power limiting will be infinite.

In certain aspects, to operate continuously within a power budget allocated to a particular tool, the lesser of the torque limit or the tool-supplied torque limit is used. In certain aspects, such a torque limit is safe to apply since it will never cause a loss of load. For example, in a case in which the Drawworks is hoisting a load requiring 10,000 Ft-Lbs (13,560 Nm) of motor torque to hold the load statically, but is hoisting at a constant angular velocity of 500 RPM (52.4 rad/sec) with a motor efficiency rating of 85%, the motor is consuming (13560×52.4)/0.85=835 kW of power (1,119 horse power). In this example, at this moment the power limit is suddenly reduced to 500 kW for the Drawworks. This limits the torque output to 5,986 Ft-Lbs, which is less than the 10,000 Ft-Lb load, but the load does not fall. Since the load is moving upwards at 500 RPM it slows down until the speed approaches 299 RPM at which point the power limited torque is 10,000 Ft-Lbs and the load continues hoisting at that constant speed.

In certain aspects, each tool controller monitors each generators total current and power individually. It is not an analog control in the sense of traditional proportional/integral/derivative controls. There are no PID loops in this control.

An iterative torque limit value is calculated and applied to reduce speed to reduce power. A new torque limit value is calculated and applied every controller cycle (e.g. 50 controller cycles per second).

The controller takes a snap-shot of the tools actual speed and consumer power is being reduced. This “locked downward ratcheted speed reference” occurs very fast in a quasi-hyperbolic fashion while approaching the available-power/consumed-power equilibrium asymptote. The locked ratcheted speed reference is applied to the drive when the power equation is satisfied.

Optionally, systems as in FIGS. 3 and 4 may have a power recovery motor system PRMS (which may be any system according to the present invention with a motor or motors for recovering power generated by rig machines and apparatuses and, in certain aspects, then re-using this power).

The power recovery motor systems PRMS may be connected to suitable control systems (e.g. a control system CS A (FIG. 4) and/or to a main control system (FIG. 4) and to control systems and/or single board computers on each utilities machine and apparatus (e.g. control system CS A, FIG. 4 and/or individual single board computer or computers, FIG. 4). Via lines L the main control system may be in communication with any item, etc. and/or with any other control system and/or computer. Also, e.g., a PRMS system, e.g., via lines N, may be so connected and in communication. The power recovery system may provide power to any item, machine, device, utility and/or apparatus on or under a rig.

In certain aspects, embodiments of the present invention use a motor as a flywheel apparatus. In one aspect an “inside out” AC permanent magnet motor rotor acts as the flywheel (or multiple motors are used). In one aspect such a motor, is a motor 900 as shown in FIG. 9, with a rotor/flywheel 903 which is a hollow cylinder constructed, e.g. of steel or aluminum, with permanent magnets 904, e.g. rare earth magnets, attached to the inner surface. A stator 905 is concentrically located within the rotor, fixed to a stationary hollow shaft 902, so that the rotor revolves around the stator/shaft assembly on a roller bearings 901. 3-phase cables 907 and optional cooling channels 908 are brought out through the stationary shaft. Speed feedback is externally provided to a Variable Frequency Drive (“VFD”) via an absolute position encoder 906. The VFD provides power back to the motor 900 and can exchange power with a power source “PS” (utility, batteries, and/or generators). Without limitation and by way of example, motors as disclosed in U.S. application Ser. No. 11/789,040 filed Apr. 23, 2007 and U.S. application Ser. No. 11/709,940 filed Feb. 22, 2007 (both co-owned with the present invention and incorporated fully herein for all purposes) may be used.

Consolidation of the motor's rotor and flywheel mechanism allow for maximum energy density in a small footprint eliminating the need for couplings and separate flywheel assemblies. In one aspect a modular flywheel/motor is rated at 225 kW continuous, with intermittent rating up to 337 kW for 30 seconds. Typical angular velocity of one design is 7200 rpm.

In either an AC or DC drilling rig, kinetic energy stored in the flywheel (or flywheels) is used to elevate the block or to assist in elevating the block. In some cases, the flywheel(s) and charging mechanism(s) are dimensioned such that their peak output is equal to or greater than the potential energy of the block. In some aspects multiple flywheels are used in order to coordinate the charging and discharging cycles of the flywheel(s) with the motion of the block and kW demand, but also to insure the mechanical and electrical designs are within the practical limits of a portable system.

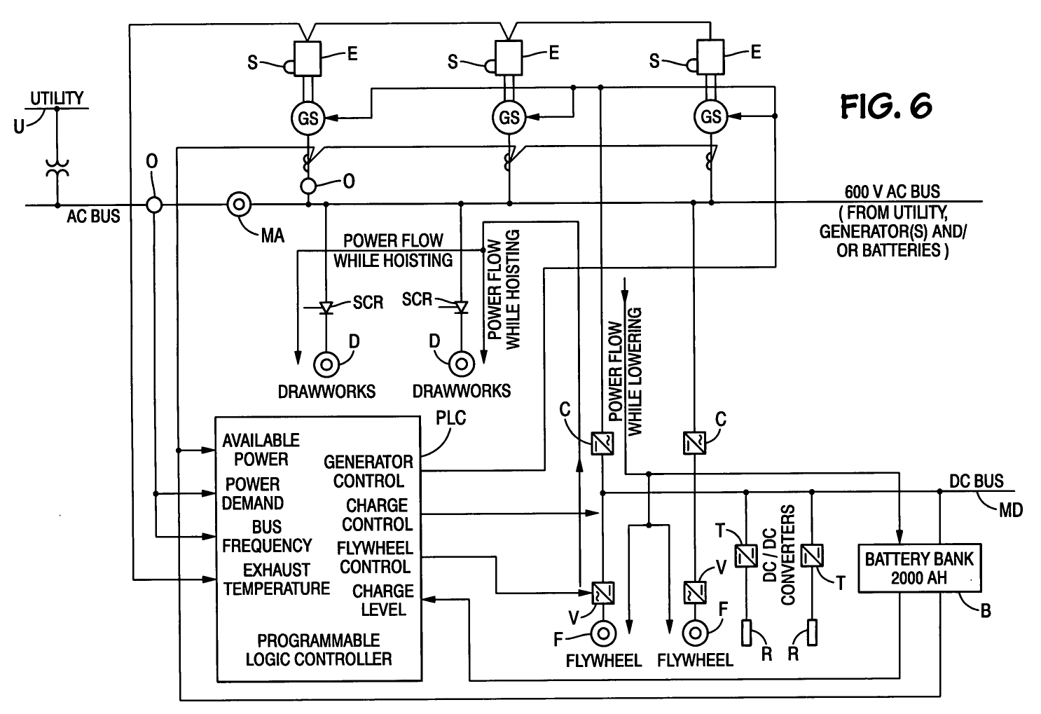

FIG. 6 shows a system 600 according to the present invention which has a plurality of rig power generators GS each with its own engine E for providing power to run the generators GS. Power from the generators GS runs multiple drawworks D. Optionally a separate utility entity U can supply power to run the generators GS and/or, optionally, such power can be supplied by a battery bank B. One, two, three or more flywheel apparatuses F (two shown) store power generated when a load is being lowered by the drawworks D and provide power as needed to run the drawworks D. Each flywheel apparatus has a drive components C and V, e.g. a fully regenerative converter and variable frequency inverter which form a complete VFD “variable frequency drive”. Optionally one or more resistor banks R (two shown) may be used for voltage control, each with a corresponding DC/DC converter or “chopper” T. A programmable logic controller PLC (or other suitable control system) controls the system 600.

In one mode, charging and discharging of the flywheels F during a braking cycle is managed by the Programmable Logic Controller PLC so that the average power drawn from the generators GS is relatively constant throughout the complete operating phases of the drawworks D. Leveling the engine load for the engines E is the job of the PLC. In one aspect, the minimum acceptable base load is 70% capacity to insure a minimum standard of efficiency and sufficiently elevated combustion temperatures (e.g. 600° F.) to allow engine emissions controls S to work properly. A D.C. Bus MD provides the direct exchange of power between the drawworks motor inverters and the flywheel motor inverters.

For a drilling rig with a system 600 as in FIG. 2, the flywheels F can be charged by using components C and V which consist of fully regenerative converter, variable frequency inverter V, and high speed permanent magnet AC motors F (e.g. but not limited to, as in FIG. 9). Active IGBT rectifiers can be used as the fully regenerative converter components C to supply both real and reactive power to match the demand of the drawwork motors. During each braking cycle, the flywheels F obtain power from an AC main bus MA through VFD components C and V, and accelerate the flywheels F to a speed whose energy exceeds the potential energy of the block. Storage of energy greater than the potential energy of the drawworks load is preferable in order to overcome losses in the mechanical and electrical systems, and maintain flywheel speeds capable of supporting adequate DC bus voltages.

To achieve this goal, the PLC monitors engine output power and available power from all connected sources. It compares these values with block speed and height, and then calculates potential energy of the load. From this information, the PLC manages the charging of the flywheels F and battery banks B (if used). Additionally, exhaust temperatures of the engines E are monitored by the PLC and factored into power management of the flywheels F and batteries of the banks B. Both power absorption and power output of the flywheels F is balanced according to engine exhaust temperatures, engine load, and available power from all connected sources.

When, in systems as the system 600, drawworks traction drives and motors impose a large volt amp reactive (“VAR”) demand on the power system, the PLC participates in the regulation of VARs. In this system, magnetizing VARs for the drawworks motors are supplied by the regenerative drive components C during low speed, high torque situations. The PLC regulates the rate VAR's is injected onto the main AC bus M. This prevents the rig generators GS from reaching VAR limits prematurely while also reducing the torque demand from the engines E during block loading.

Since improved engine throttle response is one of intended outcomes of this system, bus frequency and voltage are monitored by sensors O for pre-determined variations. Corrective action is applied by the PLC by injection of real and/or reactive power according to the degree that either bus frequency or voltage deviate from the pre-determined values. Bus frequency feedback along with upward block speed are used by the PLC to determine the rate at which power from the flywheels F is injected onto the main bus M. Silican controlled rectifier drives, SCR, control output power and speed of the drawworks DC traction motors.

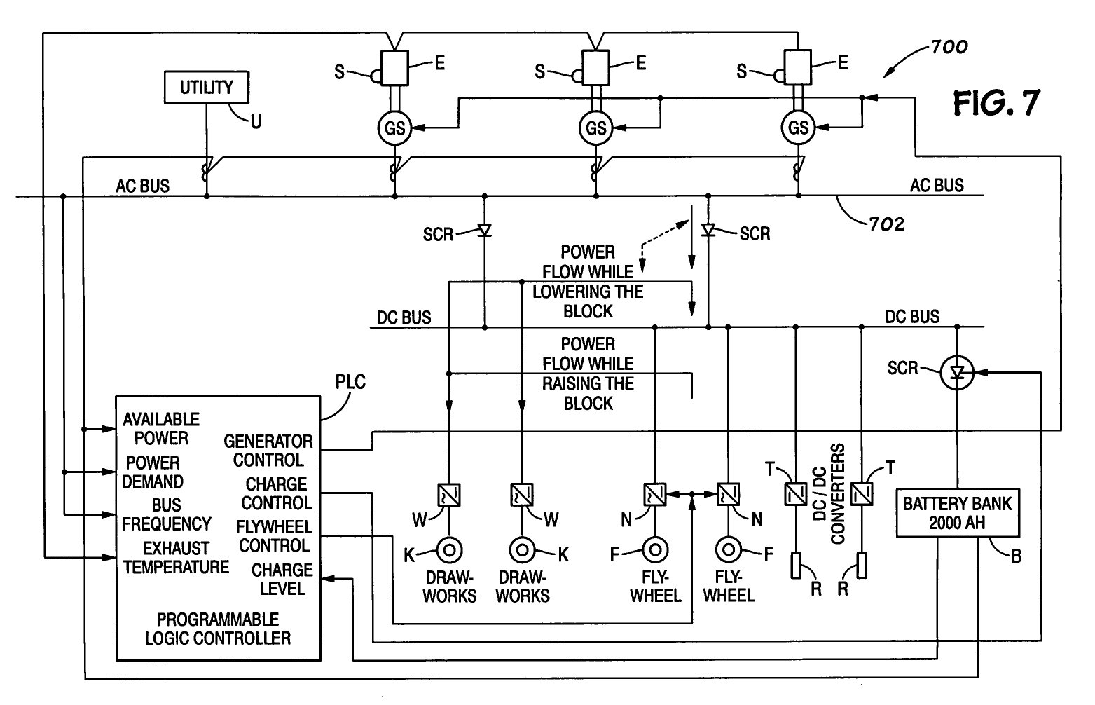

FIG. 7 shows a system 700 according to the present invention with some parts and components like those of the system 600 (and like parts and components have the same identifiers in FIG. 6 and FIG. 7). The drive components C in the system of FIG. 6 are not needed in the system of FIG. 7 which uses AC-powered motors for its drawworks K. In the system 700 power is exchanged between flywheel inverters N and drawworks inverters W across the DC bus. VARs are supplied directly to the AC motors of the drawworks from the drawworks inverters W so VAR injection on an AC bus 702 is not required. Systems with a DC drawworks manage both kW and kVAR injection at a main AC bus (FIG. 6). As with the case of a DC drawworks, control of the flywheels F is based on power demand, available power, and exhaust temperatures of the engines E. As is the case with DC drawworks, energy to overcome mechanical losses and drive inefficiencies is supplied from external sources including, but not limited to, the generators GS, utilities U, or battery banks B.

In one particular example a rig with three 1500 kW engines E will operate with a base load of 2500 kW. Therefore, each engine E is operating at 83% capacity. Operation of the drawworks K demands an additional 1000 kW intermittently (for example, 30 seconds). Total power demand is 3500 kW while operating the drawworks K. Without an energy storage mechanism such as the flywheels F, an additional engine E is required to run in reserve in order to supply power for the peak load. With three engines on line, their output can vary from 55.5% capacity to 77.7% capacity, so average engine demand is 66.7%. Fuel efficiency is poor and loading is insufficient to reliably operate the installed emissions controls on the engines. With flywheels F utilized in this case, 660 kW are available during the period of the drawworks K is not performing work. Therefore a constant charging power of 6500 kW is drawn from the source (three generators on line) during braking and rest cycles and stored in the flywheels F. When the drawworks K hoists the block, the available power is now 3500 kW-3000 kW supplied by the engines E and the remaining 500 kW supplied by the flywheels F. In this example, each engine's load varies 16.7%, increasing from 83.3% to 100%. Managing engine power in this manner satisfies these objectives—efficient operating range for the engines, adequate exhaust temperatures, (e.g. in certain aspects about 750° F. natural gas engines, and 600° F. for selective catalyst systems), and a relatively small change in engine demand that will not affect operations or affects this only minimally. Exhaust temperatures are maintained by maintaining engine loading at sufficient levels e.g., in certain aspects above 70% of maximum, e.g. by leveling the load with flywheels. Without the flywheels, the engine loading swings from 55.5% to 100%, which violates the 70% minimum load requirement for several minutes during each drawworks “tripping cycle”. Using the flywheels, engines are loaded by the flywheels during the minimum demand, and then contribute power during the maximum demand, so the average load on the engines is always above 70%. In certain aspects using engine exhaust temperature as the primary feedback is how power is managed in this utilization of the flywheels. In other power systems according to the present invention that employ a flywheel, the object is to stabilize the power system and recover energy. In certain aspects emission levels are maintained within regulations set by the EPA or other regulatory agencies or bodies.

In certain aspects of the present invention, the use of flywheels and battery banks permits novel modes of operation in well service rigs (also known as “workover rigs”). Well service rigs employing only a drawworks as a primary consumer of electric power can take advantage of the systems according to the present invention e.g. as shown in FIGS. 6 and 7. Such systems can operate entirely on battery power, utility power, or a combination of both. Depending on the available power from the local utility, U, the PLC utilizes all available utility power and draws the balance from the battery bank. In a hybrid mode of operation, flywheel control is focused on conservation of energy from the drawworks. This means that excess energy is stored in the battery banks, whenever possible. The rig generator (typically one per rig) is used only to charge depleted batteries, or when loading is such that it is impossible to operate otherwise.

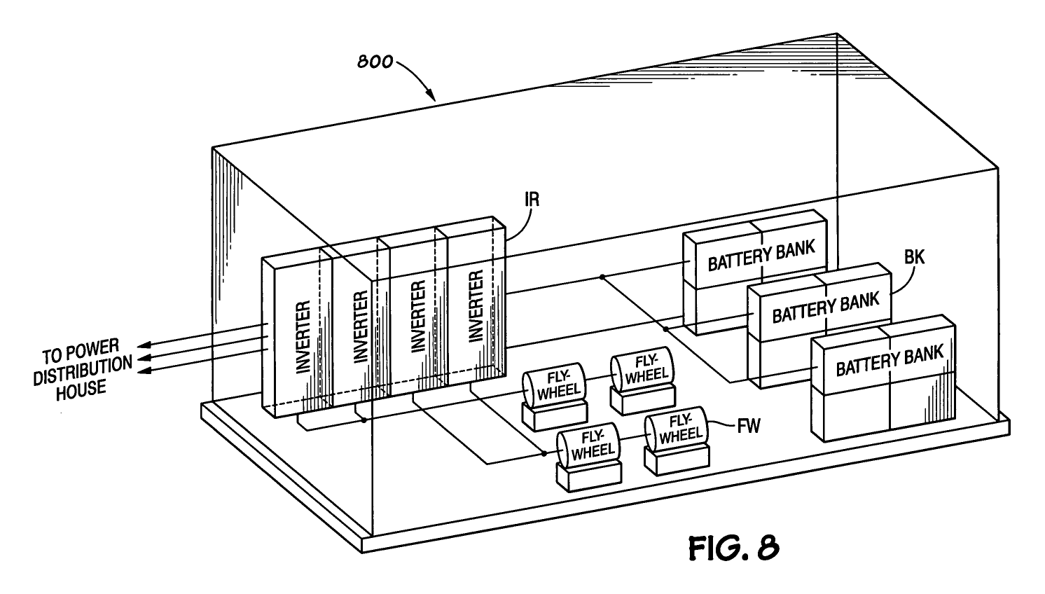

In areas where there is no utility power available, the PLC brings the generator on and off line as required to charge the battery banks and/or operate the block. In this mode, the battery bank is the primary supplier of electric power to the drawworks inverters. Engine cycling will depend on the charge level of the battery bank and the rate of discharge of the battery bank. Charging of the battery bank is also possible from the rig engine while moving from one location to the next; of from a charging station connected to a local utility. FIG. 8 shows a system 800 for use in such a way with inverter(s) IR, battery bank(s) BK, and flywheels FW (which may be any inverter, any battery bank, and any flywheel apparatus disclosed herein).

The present invention, therefore, provides in at least certain embodiments, a system for controlling power load to a rig engine of a wellbore rig, the system including a controller for controlling a rig engine; a sensor for sensing the exhaust temperature of a rig engine, the sensor in communication with the controller for providing to the controller signals indicative of the exhaust temperature; and the controller maintaining power load to the rig engine based on said exhaust temperature. Such a screen may have one or some, in any possible combination, of the following: wherein the rig engine has a rated capacity (e.g. in kilowatts) and wherein the controller provides a sufficient power load to the rig engine to maintain the rig engine in operation at at least seventy percent of the engine rated capacity; wherein the rig engine is a natural gas powered engine; flywheel apparatus for storing generated power for powering the rig engine, and the controller controlling the flywheel apparatus; wherein the flywheel apparatus is an inside-out AC motor; wherein power is applied to the flywheel apparatus, the system includes drawworks apparatus, said power generated by braking of the drawworks apparatus; wherein the drawworks apparatus used to move a travelling block of the rig and a peak output of the flywheel apparatus is at least equal to potential energy of the travelling block; wherein the drawworks apparatus is powered by an inside-out AC permanent magnet motor; wherein said peak output is greater than said potential energy; rig generator apparatus for generating power to operate a drawworks system; the controller for controlling the rig generator apparatus; wherein the controller controls power charging and power discharging of the flywheel apparatus so that average power from the rig generator apparatus is relatively constant during operation of the drawworks system; power source for supplying power to the rig engine, the controller monitoring available power from the power source; wherein the power source is any of utility, battery, rig generator, and flywheel apparatus and the controller monitors power available from any utility power source, rig generator power source, battery power source, and flywheel apparatus power source; wherein the controller compares values for available power to travelling block speed and height and, based on these values, calculates potential energy of the block and controls power charging of any flywheel apparatus and battery; wherein there is a flywheel apparatus and the controller regulates power input to the flywheel apparatus with power output from the flywheel apparatus based on rig engine exhaust temperature, all available power, and desired power load to the rig engine; rig generator apparatus, the controller for preventing the rig generator apparatus from exceeding VAR limits; a main power bus for sharing available power, the controller for determining rate at which power from the flywheel apparatus is supplied to the main power bus to facilitate engine throttle response; wherein the rig engine supplies power for a well service rig, the system further including a utility power source, a rig generator power source, a battery power source, a flywheel apparatus for storing power generated by operation of a rig drawworks system, the controller for controlling power supplied to the rig engine; wherein the controller brings the rig generator on and off line to charge the battery power source and/or to operate the drawworks; wherein the controller controls the power sources so that the drawworks operates solely on power from only the battery power source; and/or wherein the controller is a programmable logic controller; and/or rig apparatuses, a plurality of rig generators for supplying power to the rig engine and to the rig apparatuses, the rig engine and each rig apparatus having a respective single board computer control, the controller for monitoring the plurality of rig generators to determine if a rig generator has failed, and each single board computer control taking into account a reduction in available power due to failure of a rig generator and each single board computer control reducing a power limit for its corresponding rig apparatus or rig engine.

The present invention, therefore, provides in at least certain embodiments, a method for controlling power to a rig engine of a wellbore rig, the method including: maintaining with a controller of a power control system power load to a rig engine based on exhaust temperature of the engine, the power control system including a controller for controlling a rig engine, a sensor for sensing the exhaust temperature of a rig engine, the sensor in communication with the controller for providing to the controller signals indicative of the exhaust temperature, and the controller maintaining power load to the rig engine based on said exhaust temperature.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to the step literally and/or to all equivalent elements or steps. The following claims are intended to cover the invention as broadly as legally possible in whatever form it may be utilized. The invention claimed herein is new and novel in accordance with 35 U.S.C. §102 and satisfies the conditions for patentability in §102. The invention claimed herein is not obvious in accordance with 35 U.S.C. §103 and satisfies the conditions for patentability in §103. This specification is in accordance with the requirements of 35 U.S.C. §112. The inventors may rely on the Doctrine of Equivalents to determine and assess the scope of their invention and of the claims that follow as they may pertain to apparatus not materially departing from, but outside of, the literal scope of the invention as set forth in the following claims. All patents and applications identified herein are incorporated fully herein for all purposes. What follows are some of the claims for some of the embodiments and aspects of the present invention, but these claims are not necessarily meant to be a complete listing of nor exhaustive of every possible aspect and embodiment of the invention. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A system for controlling power load to a rig engine of a wellbore rig, the system comprising
a controller for controlling a rig engine,
a sensor for sensing the exhaust temperature of a rig engine, the sensor in communication with the controller for providing to the controller signals indicative of the exhaust temperature, and
the controller maintaining power load to the rig engine based on said exhaust temperature.

2. The system of claim 1 wherein the rig engine has a rated capacity and wherein the controller provides a sufficient power load to the rig engine to maintain the rig engine in operation at at least seventy percent of the engine rated capacity.

3. The system of claim 1 wherein the rig engine is a natural gas powered engine.

4. The system of claim 1 further comprising
flywheel apparatus for storing generated power for powering the rig engine, and
the controller controlling the flywheel apparatus.

5. The system of claim 4 wherein the flywheel apparatus is an inside-out AC motor.

6. The system of claim 4 wherein power is applied to the flywheel apparatus, the system includes drawworks apparatus, said power generated by braking of the drawworks apparatus.

7. The system of claim 6 wherein the drawworks apparatus used to move a travelling block of the rig and a peak output of the flywheel apparatus is at least equal to potential energy of the travelling block.

8. The system of claim 6 wherein the drawworks apparatus is powered by an inside-out AC permanent magnet motor.

9. The system of claim 7 wherein said peak output is greater than said potential energy.

10. The system of claim 4 further comprising
rig generator apparatus for generating power to operate a drawworks system, and
the controller for controlling the rig generator apparatus.

11. The system of claim 10 wherein the controller controls power charging and power discharging of the flywheel apparatus so that average power from the rig generator apparatus is relatively constant during operation of the drawworks system.

12. The system of claim 1 further comprising
power source for supplying power to the rig engine, and
the controller monitoring available power from the power source.

13. The system of claim 12 wherein the power source is any of utility, battery, rig generator, and flywheel apparatus and the controller monitors power available from any utility power source, rig generator power source, battery power source, and flywheel apparatus power source.

14. The system of claim 13 wherein the controller compares values for available power to travelling block speed and height and, based on these values, calculates potential energy of the block and controls power charging of any flywheel apparatus and battery.

15. The system of claim 14 wherein there is a flywheel apparatus and the controller regulates power input to the flywheel apparatus with power output from the flywheel apparatus based on rig engine exhaust temperature, all available power, and desired power load to the rig engine.

16. The system of claim 1 further comprising
rig generator apparatus, and
the controller for preventing the rig generator apparatus from exceeding VAR limits.

17. The system of claim 4 further comprising
a main power bus for sharing available power, and
the controller for determining rate at which power from the flywheel apparatus is supplied to the main power bus to facilitate engine throttle response.

18. The system of claim 1 wherein the rig engine supplies power for a well service rig, the system further comprising
a utility power source,
a rig generator power source,
a battery power source,
a flywheel apparatus for storing power generated by operation of a rig drawworks system, and
the controller for controlling power supplied to the rig engine.

19. The system of claim 18 wherein the controller brings the rig generator on and off line to charge the battery power source and/or to operate the drawworks.

20. The system of claim 18 wherein the controller controls the power sources so that the drawworks operates solely on power from only the battery power source.

21. The system of claim 1 wherein the controller is a programmable logic controller.

22. The system of claim 1 further comprising
rig apparatuses,
a plurality of rig generators for supplying power to the rig engine and to the rig apparatuses,
the rig engine and each rig apparatus having a respective single board computer control,
the controller for monitoring the plurality of rig generators to determine if a rig generator has failed, and
each single board computer control taking into account a reduction in available power due to failure of a rig generator and each single board computer control reducing a power limit for its corresponding rig apparatus or rig engine.

23. A method for controlling power to a rig engine of a wellbore rig, the method comprising
maintaining with a controller of a power control system power load to a rig engine based on exhaust temperature of the engine, the power control system comprising a controller for controlling a rig engine, a sensor for sensing the exhaust temperature of a rig engine, the sensor in communication with the controller for providing to the controller signals indicative of the exhaust temperature, and the controller maintaining power load to the rig engine based on said exhaust temperature.
